(19) United States
(12) Patent Application Publication
(10) Pub. No.: US 2007/0284963 A1
(43) Pub. Date: Dec. 13, 2007

(54) Rotor for tandem type alternator and tandem type alternator using such rotor

(75) Inventors: Takuzou Mukai, Handa-shi (JP); Shin Kusase, Oobu-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/783,241

(22) Filed: Apr. 6, 2007

(30) Foreign Application Priority Data
Jun. 7, 2006 (JP) 2006-158512

(51) Int. Cl. H02K 47/00; H02K 1/22; H02K 19/38

(52) U.S. Cl. 310/263; 310/112

(57) ABSTRACT

A rotor for a tandem type alternator and a tandem type alternator having such a rotor are disclosed. The rotor comprises front and rear Lundell-type rotor cores, carried on a rotary shaft adjacent to each other, which include front and rear rotor coils, respectively, and front and rear claw-shaped pole portions surrounding the front and rear rotor coils, respectively. The rear Lundell-type rotor core has a rear end face including a convexed portion, formed around the rotary shaft, in which a large diameter stepped portion of the rotary shaft and a plurality of relay terminals associated therewith are accommodated in an area close proximity to the rear Lundell-type rotor core, enabling an axial length of the rotary shaft between front and rear bearings to be shortened to increase the number of allowable maximum revolutions of the rotor by that extent.

### CROSS REFERENCE TO RELATED APPLICATIONS

This application is related to Japanese Patent Application No. No. 2006-158512, filed on Jun. 7, 2006, the content of which is hereby incorporated by reference.

### BACKGROUND OF THE INVENTION

1. Technical Field of the Invention

The present invention relates to rotors of tandem type alternators and, more particularly, to a rotor for a tandem type alternator and the tandem type alternator employing such a rotor especially for use in high-speed applications.

2. Description of the Related Art

In the related art, attempts have heretofore been made to provide tandem type alternators each including a pair of Lundell-type rotor cores carried on a rotary shaft in tandem arrangement which have a radially face-to-face relationship with respective stators as disclosed in Japanese Patent Unexamined Application Publication Nos. 5-83906 and 5-122997. Each of these tandem alternators can output two kinds of output voltages independently controllable with a single power generator, enabling power generation circuits of two power source systems for a vehicle to be simplified.

With each of the tandem type alternators proposed in the related arts, however, the two Lundell-type rotor cores are provided on the common rotary shaft in tandem arrangement between a pair of bearings. This causes the rotor to take a long span in an axial length between the associated bearings. In addition, a rotating inertial mass of the rotor increases. This causes an issue to arise with a difficulty of increasing allowable maximal revolutions. As known in the art, since the output of the rotating machine has the correlation with a circumferential velocity of the Lundell-type rotor core on an outer circumferential periphery thereof, a reduction in the allowable maximal revolutions causes the alternator to provide outputs lowered by that extent. For a demanded output to be obtained, the Lundell-type rotor cores need to have increased diameters or increased axial lengths. This requires the Lundell-type rotor cores to decrease the allowable maximal revolutions. In addition, increasing diameters of rotational axes of the Lundell-type rotor cores is effective for the allowable maximal revolutions to increase. However, increases in diameters of the rotational axes cause reductions in field magnetic flux contents of the Lundell-type rotor cores with the resultant drop in outputs of the alternator. Another issue arises with the occurrence of bearings taking large sizes in diameter.

### SUMMARY OF THE INVENTION

The present invention has been completed with a view to addressing the above issues and has an object to provide a rotor for a tandem type alternator and a tandem type alternator employing such a rotor that can take a simplified structure to provide an increased output per body mass.

To achieve the above object, a first aspect of the present invention provides a rotor for a tandem type alternator, comprising a rotary shaft and front and rear Lundell-type rotor cores, carried on the rotary shaft adjacent to each other, which include first boss portions carrying thereon a front rotor coil and second boss portions carrying thereon a rear rotor coil, respectively, front claw-shaped pole portions radially extending from the first boss portions of the front Lundell-type rotor core and axially extending so as to surround the front rotor coil, and rear claw-shaped pole portions radially extending from the second boss portions of the rear Lundell-type rotor core and axially extending so as to surround the rear rotor coil. A front bearing rotatably supports the rotary shaft on a front end thereof and is placed in close proximity to a front end of one of the first boss portions of the front Lundell-type rotor core. A rear bearing rotatably supports the rotary shaft on a rear end thereof and is placed in close proximity to a rear end of one of the second boss portions of the rear Lundell-type rotor core. At least one of the front and rear Lundell-type rotor cores has a ring shaped convexed portion formed around the rotary shaft.

With the rotor of such a structure, at least one of the front and rear Lundell-type rotor cores has a ring shaped convexed portion formed around the rotary shaft. By so doing, the ring shaped convexed portion can accommodate a whole of or part of a bearing mechanism or a large diameter stepped portion formed on the output shaft as a stopper. This allows the rotor to have a reduced axial length between the front and rear bearings to permit a critical speed. This results in an increase in allowable maximal revolutions and the tandem type alternator, employing such a rotor, can provide an increased output per body mass.

In a preferred embodiment, the convexed portion may be formed on the boss portion of one of the front and rear Lundell-type rotor cores to be larger in diameter than a diameter of the bearing adjacent to the convexed portion and the bearing adjacent to the convexed portion overlaps the boss portion formed with the convexed portion in an axial direction of the rotary shaft.

With such a structure, the rotor can have a reduced axial length between the front and rear bearings, thereby permitting critical speed of the rotor to increase. This enables allowable maximal revolutions of the rotor to increase, thereby allowing the tandem type alternator to provide an increased output.

In the preferred embodiment, the convexed portion may be formed only on a rear end face of one of the second boss portions of the rear Lundell-type rotor core in an area of close proximity to the rear bearing that is made smaller in diameter than that of the front bearing.

With such a structure, the convexed portion can be formed on the boss portion of the rear Lundell-type rotor core at a position closer to the rear bearing that is comparatively smaller in diameter than that of the front bearing. This allows the rear bearing to be easily accommodated in the convexed portion while enabling the convexed portion to be formed in a small size. This provides an ease of designing a field magnetic flux circuit of the rear Lundell-type rotor core.

In the preferred embodiment, the convexed portion may be formed in only one piece, having a larger diameter than that of the other, of the first and second boss portions of the front and rear Lundell-type rotor cores.

With such a structure, the convexed portion is formed on the Lundell-type rotor core whose boss portions have a comparatively large outer diameter, making it easy for the boss portion to be ensured to have a magnetic path surface area.

In the preferred embodiment, the convexed portion may be formed only on one, having a less maximal magnetic path sectional area, of the front and rear Lundell-type rotor cores. With such a Lundell-type rotor core, the boss portion originally has the less maximal magnetic path sectional area and less magnetic path sectional area and, therefore, the provision of the convexed portion provides an ease of addressing the issue of a reduction in a field magnetic flux content.

In the preferred embodiment, the rotary shaft may have a large diameter stepped portion accommodated in the convexed portion for restricting axial displacements of the front and rear Lundell-type rotor cores.

Even with the rotary shaft provided with the large diameter stepped portion, the presence of the convexed portion can prevent an increase in the axial length of the rotary shaft.

In the preferred embodiment, the rotor of the tandem type alternator may further comprise relay terminals, radially extending from the large diameter stepped portion of the rotary shaft, which are electrically connected to the front and rear rotor coils to apply excitation currents thereto.

By so doing, even with the relay terminals located on the large diameter stepped portion of the rotary shaft, the convexed portion can accommodate the relay terminals and the large diameter stepped portion of the rotary shaft, thereby preventing the rotor from having an increase in the axial length of the rotary shaft.

A second aspect of the present invention provides a tandem type alternator, comprising a housing having front and rear bearings axially spaced from each other, a rotary shaft rotatably supported with the housing by means of the front and rear bearings, and front and rear Lundell-type rotor cores, carried on the rotary shaft adjacent to each other, which include first boss portions carrying thereon a front rotor coil and second boss portions carrying thereon a rear rotor coil, respectively, front claw-shaped pole portions radially extending from the first boss portions of the front Lundell-type rotor core and axially extending so as to surround the front rotor coil, and rear claw-shaped pole portions radially extending from the second boss portions of the rear Lundell-type rotor core and axially extending so as to surround the rear rotor coil. At least one of the front and rear Lundell-type rotor cores has a ring shaped convexed portion formed around the rotary shaft.

With the rotor of such a structure, at least one of the front and rear Lundell-type rotor cores has a ring shaped convexed portion formed around the rotary shaft. Thus, the ring shaped convexed portion can accommodate a whole of or part of a bearing mechanism or a large diameter stepped portion formed on the output shaft as a stopper. Accordingly, the rotor can have a reduced axial length between the front and rear bearings to permit a critical speed. This enables allowable maximal revolutions to increase and the tandem type alternator, employing such a rotor, can provide an increased output per body mass.

In a preferred embodiment of the tandem type alternator, the convexed portion may be formed on the boss portion of one of the front and rear Lundell-type rotor cores to be larger in diameter than a diameter of the bearing adjacent to the convexed portion, and the bearing adjacent to the convexed portion overlaps the boss portion formed with the convexed portion in an axial direction of the rotary shaft.

With such a structure, the rotor can have a reduced axial length between the front and rear bearings, thereby permitting critical speed of the rotor to increase. This enables allowable maximal revolutions of the rotor to increase, thereby allowing the tandem type alternator to provide an increased output.

In the preferred embodiment of the tandem type alternator, the convexed portion may be formed only on a rear end face of one of the second boss portions of the rear Lundell-type rotor core in an area close proximity to the rear bearing that is made smaller in diameter than that of the front bearing. By so doing, the convexed portion can be formed on the boss portion of the rear Lundell-type rotor core at a position closer to the rear bearing that is comparatively smaller in diameter than that of the front bearing. Accordingly, the rear bearing can be easily accommodated in the convexed portion while enabling the convexed portion to be formed in a small size. Thus, the rear Lundell-type rotor core can be easily designed to have an optimum field magnetic flux circuit.

In the preferred embodiment of the tandem type alternator, the convexed portion may be formed only in one, having a larger diameter than that of the other, of the first and second boss portions of the front and rear Lundell-type rotor cores. By so doing, the convexed portion is formed on the Lundell-type rotor core whose boss portions have a comparatively large outer diameter, making it easy to ensure that the boss portion has a magnetic path surface area.

In the preferred embodiment of the tandem type alternator, the convexed portion may be formed only on one, having a less maximal magnetic path sectional area, of the front and rear Lundell-type rotor cores. With such a Lundell-type rotor core, the boss portion originally has the less maximal magnetic path sectional area and less magnetic path sectional area and, therefore, the provision of the convexed portion enables to easily address the issue of a reduction in a field magnetic flux content.

In the preferred embodiment of the tandem type alternator, the rotary shaft may have a large diameter stepped portion accommodated in the convexed portion for restricting axial displacements of the front and rear Lundell-type rotor cores. Even with the rotary shaft provided with the large diameter stepped portion, the presence of the convexed portion can prevent the rotary shaft from having an increased axial length.

In the preferred embodiment, the tandem type alternator may further comprise relay terminals, radially extending from the large diameter stepped portion of the rotary shaft, which are electrically connected to the front and rear rotor coils to apply excitation currents thereto. With such a structure, even with the relay terminals located on the large diameter stepped portion of the rotary shaft, the relay terminals and the large diameter stepped portion of the rotary shaft can be accommodated in the convexed portion can accommodate, thereby preventing the rotor from having an increase in the axial length of the rotary shaft.

A third aspect of the present invention provides a tandem type alternator, comprising a housing having front and rear bearings axially spaced from each other, a rotary shaft rotatably supported with the housing by means of the front and rear bearings, and front and rear Lundell-type rotor cores, carried on the rotary shaft adjacent to each other, which include first boss portions carrying thereon a front rotor coil and second boss portions carrying thereon a rear rotor coil, respectively, front claw-shaped pole portions radially extending from the first boss portions of the front Lundell-type rotor core and axially extending so as to surround the front rotor coil, and rear claw-shaped pole portions radially extending from the second boss portions of the rear Lundell-type rotor core and axially extending so as to surround the rear rotor coil. The second boss portions of the rear Lundell-type rotor core have a larger diameter than that of the first boss portions of the front Lundell-type rotor core. The rear Lundell-type rotor core has a rear end face formed with a ring shaped convexed portion around the rotary shaft.

With such a structure of the tandem type alternator, the rear Lundell-type rotor cores has a ring shaped convexed portion formed around the rotary shaft. Thus, the ring shaped convexed portion can accommodate a whole of or part of the rear bearing and the large diameter stepped portion of the output shaft acting as a stopper. Thus, the rotor can have a reduced axial length between the front and rear bearings to permit a critical speed. Accordingly, the rotor can have increased allowable maximal revolutions and the tandem type alternator, employing such a rotor, can provide an increased output per body mass.

In a preferred embodiment, the convexed portion may be formed on the boss portion of one of the front and rear Lundell-type rotor cores to be larger in diameter than a diameter of the bearing adjacent to the convexed portion, and the bearing adjacent to the convexed portion overlaps the boss portion formed with the convexed portion in an axial direction of the rotary shaft. With such a structure, the rotor can reduce an axial length between the front and rear bearings, resulting in an increase in a critical speed of the rotor. Accordingly, allowable maximal revolutions of the rotor can be increased, thereby allowing the tandem type alternator to provide an increased output.

In a preferred embodiment, the convexed portion may be formed on the boss portion of the rear Lundell-type rotor core to be larger in diameter than a diameter of the rear bearing, and the rear bearing may overlap the boss portion of the rear Lundell-type rotor core in an axial direction of the rotary shaft. By so doing, the convexed portion can be formed on the boss portion of the rear Lundell-type rotor core and the rear bearing can be easily accommodated in the convexed portion while enabling the convexed portion to be formed in a small size. Thus, the rear Lundell-type rotor core can be easily designed to have an optimum field magnetic flux circuit.

In the preferred embodiment, the rear rotor coil may be larger in diameter than that of the front rotor coil. With such a structure, the rear end face of the boss portion of the rear Lundell-type rotor core can be formed with the convexed portion to achieve a reduction in axial length of the front and rear bearings, while ensuring an optimum magnetic path sectional area of the rear Lundell-type rotor core.

In the preferred embodiment, the rotary shaft may have a large diameter stepped portion accommodated in the convexed portion for restricting axial displacements of the front and rear Lundell-type rotor cores. By so doing, the large diameter stepped portion of the rotary shaft can be accommodated in the convexed portion formed on the rear Lundell-type rotor core. This achieves a reduction in axial length of the rotor between the front and rear bearings, providing an increase in critical speed of the rotor thereby permitting the tandem type alternator to have an increased output.

In the preferred embodiment, the tandem type alternator may further comprise relay terminals, radially extending from the large diameter stepped portion of the rotary shaft, which are electrically connected to the front and rear rotor coils to apply excitation currents thereto. With such a structure, component parts for supplying excitation currents to the front and rear rotor coils can be accommodated in a compact structure in a simplified arrangement. This contributes a reduction in axial length of the rotor between the front and rear bearings. Thus, the rotor can be rotated at high critical speed, thereby permitting the tandem type alternator to have an increased output.

In the preferred embodiment, the rear Lundell-type rotor core may include a rear pole core, formed with the convexed portion, which has a radially outward annular portion formed in an area radially outward the convexed portion. With such a structure, the presence of the radially outward annular portion is effective to ensure the boss portion of the rear Lundell-type rotor core to have a demanded magnetic path sectional area. This prevents a drop in an output of the alternator.

A fourth aspect of the present invention provides a tandem type alternator, comprising a housing having front and rear bearings axially spaced from each other, a rotary shaft, rotatably supported with the housing by means of the front and rear bearings, which has a main shaft portion, a large diameter stepped portion formed on a rear end of the main shaft portion, and a rear end portion axially extending rearward from the large diameter stepped portion so as to axially extend from the rear bearing and carrying thereon slip rings, brushes with the housing and held in siding contact with the slip rings of the rotary shaft, a plurality of relay terminals associated with the large diameter stepped portion of the rotary shaft, and front and rear stators carried on the housing in an axially spaced relationship. Front and rear Lundell-type rotor cores, carried on the rotary shaft adjacent to each other in positions radially inward the front and rear stators, respectively, include first boss portions carrying thereon a front rotor coil and second boss portions carrying thereon a rear rotor coil, respectively, front claw-shaped pole portions radially extending from the first boss portions of the front Lundell-type rotor core and axially extending so as to surround the front rotor coil, and rear claw-shaped pole portions radially extending from the second boss portions of the rear Lundell-type rotor core and axially extending so as to surround the rear rotor coil, the front and rear rotor coils being supplied with excitation currents through the relay terminals and the slip rings. The second boss portions of the rear Lundell-type rotor core have a larger diameter than that of the first boss portions of the front Lundell-type rotor core. The rear Lundell-type rotor core has a rear end face formed with a ring shaped convexed portion around the rotary shaft to accommodate therein the large diameter stepped portion of the rotary shaft and the relay terminals.

With such a structure of the tandem type alternator, the second boss portions of the rear Lundell-type rotor core have a larger diameter than that of the first boss portions of the front Lundell-type rotor core. In addition, the rear Lundell-type rotor core has a rear end face formed with a ring shaped convexed portion around the rotary shaft to accommodate therein the large diameter stepped portion of the rotary shaft and the relay terminals. This enables a design to be easily performed to ensure the rear Lundell-type rotor core to have a demanded magnetic path sectional area to achieve required high performance of the alternator. In addition, the ring shaped convexed portion can accommodate a whole of or part of the rear bearing and the large diameter stepped portion of the output shaft acting as a stopper. Thus, the rotor can have a reduced axial length between the front and rear bearings to permit a critical speed. Accordingly, the rotor can have increased allowable maximal revolutions and the tandem type alternator, employing such a rotor, can provide an increased output per body mass in a simplified structure.

In the preferred embodiment, the front and rear stators, the front and rear rotor coils and the convexed portion of the rear Lundell-type rotor core may lie in a relationship expressed as:

$$B / A \approx \frac{φ {D}^{2} - φ {C}^{2}}{φ {d}^{2}}$$

where A, B represent axial lengths of the front and rear stators respectively, φd, φD represent inner diameters of the front and rear rotor coils, respectively, and φC represents an inner diameter of the convexed portion.

With such a relationship among the associated component parts, it is possible to easily design alternator's front and rear stators, front and rear rotor coils and the convexed portion of the rear Lundell-type pole core in respective dimensions so as to allow the alternator to provide the maximum power output per body mass.

### BRIEF DESCRIPTION OF THE DRAWINGS

FIG. 1 is a cross sectional area of a tandem type alternator incorporating a rotor of one embodiment according to the present invention.

FIG. 2 is a cross sectional area of the rotor shown in FIG. 1 in an enlarged scale.

### DETAILED DESCRIPTION OF PREFERRED EMBODIMENTS

Now, a vehicle alternator, employing a rotor for a tandem type alternator, of an embodiment according to the present invention will be described below in detail with reference to the accompanying drawings. However, the present invention is construed not to be limited to such an illustrated embodiment described below and technical concepts of the present invention may be implemented in combination with other known technologies or other technologies having required functions equivalent to such known technologies.

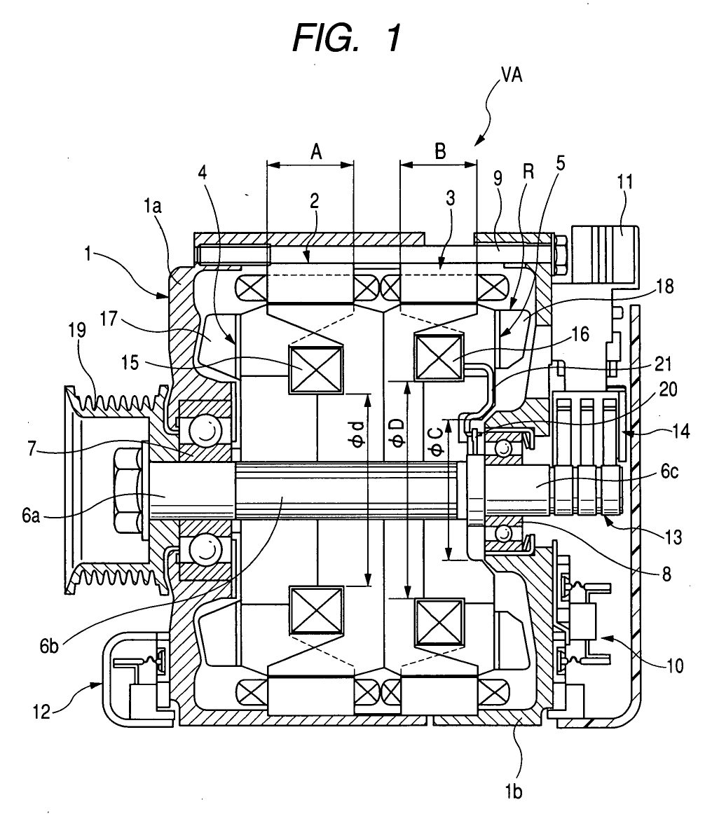

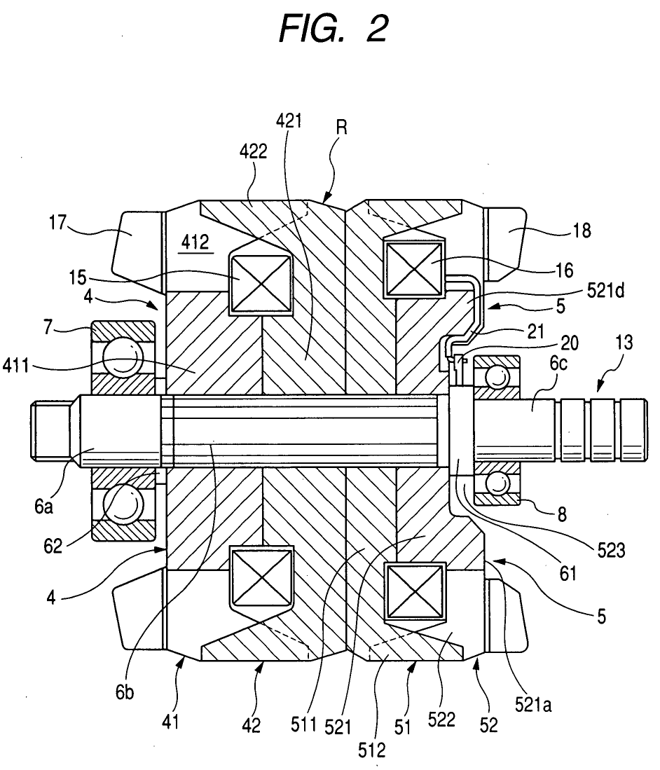

The vehicle alternator of the present embodiment will be described below with reference to FIGS. 1 and 2. FIG. 1 is a typically axial cross sectional view of the vehicle alternator of the present embodiment according to the present invention and FIG. 2 is an enlarged axial cross sectional view showing an essential part of the vehicle alternator of the present embodiment.

(Overall Structure)

An overall structure of the vehicle alternator of the present embodiment will be described below with reference to shown in FIG. 1.

As shown in FIG. 1, the vehicle alternator VA comprises a housing 1, composed of a front housing 1a and a rear housing 1b axially spaced apart from each other in a coaxial relationship, a front stator 2 and a rear stator 3 carried with the housing 1, and a rotor R including a front Lundell-type rotor core 4 fixedly mounted on a rotary shaft 6 to be rotatable inside the front stator 2, and a rear Lundell-type rotor core 5 fixedly mounted on the rotary shaft 6 adjacent to the front Lundell-type rotor core 4 to be rotatable inside the rear stator 3.

The rotary shaft 6 has a front end portion 6a rotatably supported with the front housing 1a by means of a front bearing 7, an intermediate shaft portion 6b carrying thereon the front and rear Lundell-type rotor cores 4,5, and a rear end portion 6c rotatably supported with the rear housing 1b by means of a rear bearing 8.

The rear housing 1b has a rear end face including one area carrying thereon a rectifier 10 and another area carrying thereon brushes 14 that are held in electrically sliding contact with slip rings mounted on a rear end portion 6c of the rotary shaft 6.

The housing 1 carries thereon output terminals 11 from which an output voltage is extracted to the outside.

As shown in FIG. 1, the front stator 2 is selected to have an axial length A and the rear stator 3 is selected to have an axial length B less than the axial length A of the front stator 2. The front Lundell-type rotor core 4 includes a front rotor coil 15 with a diameter φd and the front Lundell-type rotor core 5 includes a rear rotor coil 16 with a diameter φD 16 selected to be larger than the diameter of the front rotor coil 15.

In addition, the front Lundell-type rotor core 4 has a front end face provided with a front cooling fan 17. Likewise, the rear Lundell-type rotor core 5 has a rear end face provided with a rear cooling fan 18. The rotary shaft 6 has a front end carrying thereon a pulley 19.

The housing 1 takes the form of a structure wherein the front housing 1a and the rear housing 1b are coupled to each other by means of a plurality of bolts 9. The front and rear housings 1a, 1b of the housing 1 have inner circumferential peripheries to which the front stator 2 and the rear stator 3 are fixedly secured in a spaced relationship from each other by a given distance.

The front Lundell-type rotor core 4 is placed radially inward the front stator 2 having the axial length A and the rear Lundell-type rotor core 5 is placed radially inward the rear stator 3 having the axial length B.

The front Lundell-type rotor core and the rear Lundell-type rotor core 5 are press fitted to the rotary shaft 6 to be non-rotatable relative to each other. The rotary shaft 6 are rotatably supported with the housing 1 by means of the front and rear bearings 7, 8. The front Lundell-type rotor core 4 and the rear Lundell-type rotor core 5 are placed in a tandem arrangement between the front bearing 7 and the rear bearing 8.

The front and rear stators 2, 3 provide outputs that are rectified with the rectifier 10 and then output from the output terminals 11. The regulator 12 serves to apply an excitation current to the rotor coil 15, wound on the front Lundell-type rotor core 4, and the rear Lundell-type rotor core 5 wound on the rear Lundell-type rotor core 5.

The front cooling fan 17, carried on the front face of the front Lundell-type rotor core 4, and the rear cooling fan 18, carried on the rear face of the rear Lundell-type rotor core 5 create front and rear cooling airstreams that are forced towards the front and rear stators 2, 3, respectively, due to respective centrifugal forces for the cooling thereof. The pulley 19 is mounted on the front end of the rotary shaft 6 in an area protruding from the front bearing 7.

A fundamental structure and fundamental operation of the tandem type alternator of this kind are known in the art and, hence, further descriptions of the tandem type alternator are herein omitted.

(Structure of Front and Rear Lundell-Type Rotor Cores 4, 5)

Structures of the front and rear Lundell-type rotor cores 4, 5, forming features of the present embodiment, will be described below in detail with reference to FIG. 2.

The front Lundell-type rotor core 4, made of a soft metal forged product, includes a pair of pole cores 41, 42 in combination that are fitted and fixed to the rotary shaft 6 adjacent to each other. The pole core 41 includes a cylindrical boss portion 411 and a requisite number of claw-shaped pole portions 412 radiating from a front end of the boss portion 411 and extending axially rearward. Likewise, the pole core 42 includes a cylindrical boss portion 421 and a requisite number of claw-shaped pole portions 422 radiating from a rear end of the boss portion 421 and extending axially forward.

The rear Lundell-type rotor core 5, made of a soft metal forged product, includes a pair of pole cores 51, 52 in combination that are fitted and fixed to the rotary shaft 6 adjacent to each other. The pole core 51 includes a cylindrical boss portion 511 and a requisite number of claw-shaped pole portions 512 radiating from a front end of the boss portion 511 and extending axially rearward. Likewise, the pole core 52 includes a cylindrical boss portion 521 and a requisite number of claw-shaped pole portions 522 radiating from a rear end of the boss portion 521 and extending axially forward.

The cylindrical boss portions 421, 511 are held in abutting contact with each other such that a rear wall of the pole core 42 is held in tight contact with a front wall of the pole core 51. The Lundell-type rotor core per se is well known in the art and, hence, a further detailed description of the same is herein omitted.

The rotary shaft 6 has a large diameter stepped portion 61, formed on the rotary shaft 6 between a rear end of the main shaft portion 6b and the rear end portion 6c, which has a larger diameter greater than that of the rear bearing 8. The large diameter stepped portion 61 intervenes between a rear end face of the boss portion 521 of the pole core 52 and a front end face of the rear bearing 8 in abutting contact therewith, thereby restricting rearward displacements of the front Lundell-type rotor core 4 and the rear bearing 8.

For a similar purpose to be achieved, a collar 62 is interposed between the front bearing 7 and a front end face of the boss portion 411 of the pole core 41. The rotary shaft 6 has a front end portion 6c, extending forward from the main shaft portion 6b, extends through the collar 62 and is fitted to an inner race of the front bearing 7 to be rotatably supported.

(Conducting Wire Layout of Rotor Coils)

The front and rear rotor coils 15, 16 are supplied with excitation currents from the three slip rings 13 via three conducting wires (not shown) buried in the rotary shaft 6. These conducting wires are electrically connected through three relay terminals (with only one relay terminal being shown in drawing figures) 20, extending from an outer circumferential periphery of the large diameter stepped portion 61 in a radial direction, to rotor coil lead wires 21 extending from the rotor coils 15, 16, respectively. The presence of the large diameter stepped portion 61, formed in an increased diameter, prevents the rotary shaft 6 from decreasing in strength due to placement of recesses, apertures for burying the conducting wires, mentioned above, and the relay terminals 20.

(Detailed Structure of Pole Core 52)

As shown in FIG. 2, with the vehicle alternator VA of the present embodiment, the pole core 52 of the rear Lundell-type rotor core 5 has a feature in that a rear end face 521a of the boss portion 521 has a convexed portion 523. The convexed portion 523 has a diameter φC greater than that of the large diameter stepped portion 61 of the rotary shaft 6, outer diametric peripheries of the relay terminals 20 and the rear bearing 8 for accommodating therein these component parts together with radially inward portions of the lead wires 21. The convexed portion 523 is formed so as to allow the pole core 522 of the rear Lundell-type pole core 52 to have a magnetic path sectional area to allow a requisite maximal magnetic flux to pass through the rear Lundell-type rotor core 5.

The axial lengths A, B of the front and rear stators 2, 3, the inner diameters φd, φD of the front and rear rotor coils 15, 16 and the diameter φC of the convexed portion 523 lie in the relationship expressed as:

$$B / A \approx \frac{φ {D}^{2} - φ {C}^{2}}{φ {d}^{2}}$$

Next, the function of the convexed portion 523 will be described more in detail. The convexed portion 523 takes the form of a substantially circular hollow portion with a shallow bottom that is formed around a through-bore 521b of the boss portion 521 through which a read end of the rotary shaft 6 extends. The convexed portion 523 allows a front end face of the rear bearing 8 to be placed forward from the rear end face of the boss portion 521 of the pole core 52, achieving a reduction in an axial length of the vehicle alternator VA. Thus, the vehicle alternator VA can have a compact structure with a shortened axial length.

In order to satisfy a demand for the magnetic path sectional area to be ensured, with the vehicle alternator VA of the present embodiment, the boss portions 511, 521 of the rear Lundell-type rotor core 5 have outer circumferential peripheries formed in larger diameter than those of the boss portions 411, 421 of the front Lundell-type rotor core 4. This enables the boss portion 521 of the rear Lundell-type rotor core 5 to easily ensure the requisite magnetic path sectional area.

However, the increases in diameters of the boss portions 511, 521 of the rear Lundell-type rotor core 5 cause a reduction of the number of turns of the rotor coil 16 and a reduction in the magnetic path sectional areas of the claw-shaped pole portions. To address such issues, with the vehicle alternator VA of the present embodiment, the rear Lundell-type rotor core 5 is allocated to a small output section with a less maximal flux quantity and the front Lundell-type rotor core 4 is allocated to a large output section with a large maximal flux quantity.

With the vehicle alternator VA of the present embodiment, further, the rotor coil 16 has an axial center position axially deviated from an axial center position of the pole core 52 toward the pole core 51. This allows the boss portion 521 of the pole core 52 to have a radially outward annular portion 521d in an area radially outward from the convexed portion 523. This easily ensures the radially outward annular portion 521d to have a magnetic path sectional area for the maximal magnetic flux content to pass.

In addition, the vehicle alternator VA of the present embodiment has another advantageous effect coming from a particular rotor structure. That is, as set forth above, the presence of the convexed portion 523, formed on the rear end face of the boss portion 521 of the pole core 52, enables the rotor R to have a shortened axial length accompanied with various advantages mentioned above as set forth above.

While the specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof. For instance, although the rotor of the alternator of the present embodiment has been described above with reference to a particular structure wherein the convexed portion 523 is formed on the rear end face of the boss portion 521 of the pole core 52 of the rear Lundell-type rotor core 5, it will be easily appreciated to those skilled in the art that the convexed portion 523 may be readily formed on a front end face of the boss portion 411 of the front Lundell-type rotor core 4 depending on needs.

What is claimed is:

1. A rotor of a tandem type alternator, comprising:
a rotary shaft;
front and rear Lundell-type rotor cores, carried on the rotary shaft adjacent to each other, which include first boss portions carrying thereon a front rotor coil and second boss portions carrying thereon a rear rotor coil, respectively, front claw-shaped pole portions radially extending from the first boss portions of the front Lundell-type rotor core and axially extending so as to surround the front rotor coil, and rear claw-shaped pole portions radially extending from the second boss portions of the rear Lundell-type rotor core and axially extending so as to surround the rear rotor coil;
a front bearing rotatably supporting the rotary shaft on a front end thereof and placed in close proximity to a front end of one of the first boss portions of the front Lundell-type rotor core; and
a rear bearing rotatably supporting the rotary shaft on a rear end thereof and placed in close proximity to a rear end of one of the second boss portions of the rear Lundell-type rotor core;
wherein at least one of the front and rear Lundell-type rotor cores has a ring shaped convexed portion formed around the rotary shaft.

2. The rotor of the tandem type alternator according to claim 1, wherein:
the convexed portion is formed on the boss portion of one of the front and rear Lundell-type rotor cores to be larger in diameter than a diameter of the bearing adjacent to the convexed portion; and
the bearing adjacent to the convexed portion overlaps the boss portion formed with the convexed portion in an axial direction of the rotary shaft.

3. The rotor of the tandem type alternator according to claim 1, wherein:
the convexed portion is formed only on a rear end face of one of the second boss portions of the rear Lundell-type rotor core in an area close proximity to the rear bearing that is made smaller in diameter than that of the front bearing.

4. The rotor of the tandem type alternator according to claim 1, wherein:
the convexed portion is formed only in one, having a larger diameter than that of the other, of the first and second boss portions of the front and rear Lundell-type rotor cores.

5. The rotor of the tandem type alternator according to claim 1, wherein:
the convexed portion is formed only on one, having a less maximal magnetic path sectional area, of the front and rear Lundell-type rotor cores.

6. The rotor of the tandem type alternator according to claim 1, wherein:
the rotary shaft has a large diameter stepped portion accommodated in the convexed portion for restricting axial displacements of the front and rear Lundell-type rotor cores.

7. The rotor of the tandem type alternator according to claim 6, further comprising:
relay terminals, radially extending from the large diameter stepped portion of the rotary shaft, which are electrically connected to the front and rear rotor coils to apply excitation currents thereto.

8. A tandem type alternator, comprising:
a housing having front and rear bearings axially spaced from each other;
a rotary shaft rotatably supported with the housing by means of the front and rear bearings; and
front and rear Lundell-type rotor cores, carried on the rotary shaft adjacent to each other, which include first boss portions carrying thereon a front rotor coil and second boss portions carrying thereon a rear rotor coil, respectively, front claw-shaped pole portions radially extending from the first boss portions of the front Lundell-type rotor core and axially extending so as to surround the front rotor coil, and rear claw-shaped pole portions radially extending from the second boss portions of the rear Lundell-type rotor core and axially extending so as to surround the rear rotor coil;
wherein at least one of the front and rear Lundell-type rotor cores has a ring shaped convexed portion formed around the rotary shaft.

9. The tandem type alternator according to claim 8, wherein:
the convexed portion may be formed on the boss portion of one of the front and rear Lundell-type rotor cores to be larger in diameter than a diameter of the bearing adjacent to the convexed portion; and
the bearing adjacent to the convexed portion overlaps the boss portion formed with the convexed portion in an axial direction of the rotary shaft.

10. The tandem type alternator according to claim 8, wherein:
the convexed portion is formed only on a rear end face of one of the second boss portions of the rear Lundell-type rotor core in an area close proximity to the rear bearing that is made smaller in diameter than that of the front bearing.

11. The tandem type alternator according to claim 8, wherein:
the convexed portion is formed only in one, having a larger diameter than that of the other, of the first and second boss portions of the front and rear Lundell-type rotor cores.

12. The tandem type alternator according to claim 8, wherein:
the convexed portion is formed only on one, having a less maximal magnetic path sectional area, of the front and rear Lundell-type rotor cores.

13. The tandem type alternator according to claim 8, wherein:
the rotary shaft has a large diameter stepped portion accommodated in the convexed portion for restricting axial displacements of the front and rear Lundell-type rotor cores.

14. The tandem type alternator according to claim 8, further comprising:
relay terminals, radially extending from the large diameter stepped portion of the rotary shaft, which are electrically connected to the front and rear rotor coils to apply excitation currents thereto.

15. A tandem type alternator, comprising:
a housing having front and rear bearings axially spaced from each other;
a rotary shaft rotatably supported with the housing by means of the front and rear bearings; and
front and rear Lundell-type rotor cores, carried on the rotary shaft adjacent to each other, which include first boss portions carrying thereon a front rotor coil and second boss portions carrying thereon a rear rotor coil, respectively, front claw-shaped pole portions radially extending from the first boss portions of the front Lundell-type rotor core and axially extending so as to surround the front rotor coil, and rear claw-shaped pole portions radially extending from the second boss portions of the rear Lundell-type rotor core and axially extending so as to surround the rear rotor coil;
wherein the second boss portions of the rear Lundell-type rotor core have a larger diameter than that of the first boss portions of the front Lundell-type rotor core; and
wherein the rear Lundell-type rotor core has a rear end face formed with a ring shaped convexed portion around the rotary shaft.

16. The tandem type alternator according to claim 15, wherein:
the convexed portion is formed on the boss portion of the rear Lundell-type rotor core to be larger in diameter than a diameter of the rear bearing; and
the rear bearing overlaps the boss portion of the rear Lundell-type rotor core in an axial direction of the rotary shaft.

17. The tandem type alternator according to claim 15, wherein:
the convexed portion is formed only on a rear end face of one of the second boss portions of the rear Lundell-type rotor core in an area close proximity to the rear bearing that is made smaller in diameter than that of the front bearing.

18. The tandem type alternator according to claim 15, wherein:
the rear rotor coil is larger in diameter than that of the front rotor coil.

19. The tandem type alternator according to claim 15, wherein:
the rotary shaft has a large diameter stepped portion accommodated in the convexed portion for restricting axial displacements of the front and rear Lundell-type rotor cores.

20. The tandem type alternator according to claim 19, further comprising:
relay terminals, radially extending from the large diameter stepped portion of the rotary shaft, which are electrically connected to the front and rear rotor coils to apply excitation currents thereto.

21. The tandem type alternator according to claim 19, wherein:
the rear Lundell-type rotor core includes a rear pole core, formed with the convexed portion, which has a radially outward annular portion formed in an area radially outward the convexed portion.

22. A tandem type alternator, comprising:
a housing having front and rear bearings axially spaced from each other;
a rotary shaft, rotatably supported with the housing by means of the front and rear bearings, which has a main shaft portion, a large diameter stepped portion formed on a rear end of the main shaft portion, and a rear end portion axially extending rearward from the large diameter stepped portion so as to axially extend from the rear bearing and carrying thereon slip rings;
brushes with the housing and held in siding contact with the slip rings of the rotary shaft;
a plurality of relay terminals associated with the large diameter stepped portion of the rotary shaft;
front and rear stators carried on the housing in an axially spaced relationship;
front and rear Lundell-type rotor cores, carried on the rotary shaft adjacent to each other in positions radially inward the front and rear stators, respectively, which include first boss portions carrying thereon a front rotor coil and second boss portions carrying thereon a rear rotor coil, respectively, front claw-shaped pole portions radially extending from the first boss portions of the front Lundell-type rotor core and axially extending so as to surround the front rotor coil, and rear claw-shaped pole portions radially extending from the second boss portions of the rear Lundell-type rotor core and axially extending so as to surround the rear rotor coil, the front and rear rotor coils being supplied with excitation currents through the relay terminals and the slip rings;
wherein the second boss portions of the rear Lundell-type rotor core have a larger diameter than that of the first boss portions of the front Lundell-type rotor core; and
wherein the rear Lundell-type rotor core has a rear end face formed with a ring shaped convexed portion around the rotary shaft to accommodate therein the large diameter stepped portion of the rotary shaft and the relay terminals.

23. The tandem type alternator according to claim 22, wherein:
the front and rear stators, the front and rear rotor coils and the convexed portion of the rear Lundell-type rotor core lie in the relationship expressed as:
$$B / A \approx \frac{φ {D}^{2} - φ {C}^{2}}{φ {d}^{2}}$$
where A, B represent axial lengths of the front and rear stators respectively, φd, φD represent inner diameters of the front and rear rotor coils, respectively, and φC represents an inner diameter of the convexed portion.
